(19) United States
(12) Patent Application Publication
(10) Pub. No.: US 2013/0062159 A1
(43) Pub. Date: Mar. 14, 2013

(54) HIGH SPEED CHECKSTAND HAVING MULTIPLE PRODUCT PATHWAYS

(71) Applicant: Karl FISCHER, Carlsbad, CA (US)

(72) Inventor: Karl FISCHER, Carlsbad, CA (US)

(21) Appl. No.: 13/620,168

(22) Filed: Sep. 14, 2012

Related U.S. Application Data
(60) Provisional application No. 61/534,882, filed on Sep. 14, 2011.

(51) Int. Cl. B65G 47/48

(52) U.S. Cl. 198/367

(57) ABSTRACT

A High Speed Checkstand having Multiple Product Pathways includes a primary stage having a customer input conveyor belt which leads to an automated high speed scanner that can quickly scan customer products and output to a conveyor to the secondary stage having a central conveyor belt that leads to a diverter which selectively diverts the advancing products to one of two available product conveyor belts. The diverter is controlled to direct product to a specific conveyor belt corresponding to a single customer's order and includes a pair of diverter arms that cooperate to direct products advancing on the central conveyor to either the right or left product conveyor belts. These product conveyor belts each lead to a bagging station where the advancing products can be collected and placed in bags for the customer.

### RELATED APPLICATIONS

This application claims the benefit of priority from U.S. Provisional Patent Application Ser. No. 61/534,882, filed by this inventor on Sep. 14, 2011, currently co-pending, and fully incorporated herein by this reference.

### FIELD OF THE INVENTION

The present invention relates generally to commercial high throughput checkstands. The present invention is more particularly, though not exclusively, directed to a grocery store checkstand that passes high product volumes.

### BACKGROUND OF THE INVENTION

Grocery stores, regardless of the type, have checkstands to process the purchases of their customers. In general, checkstands are required to identify the products being purchased, determine the cumulative charges, accept a payment for those charges from the customer, and facilitate the bagging of the products for the customer. Despite the necessity of such checkstands, there has been little development in creating high-speed checkstands. Indeed, even with computer barcode scanners, the checkstand is still the primary bottleneck to processing customers through a store

To address the bottleneck, the heretofore solution was to simply add additional checkstands to the store. However, since there is finite floor space available for checkstands, there is inevitably a wait for the customer to purchase her products.

In order to streamline the checkout process, some stores have transitioned some of the areas occupied by traditional checkstands to self-checkout checkstands. These checkstands are equipped with a scanning device and a payment acceptance device. While these self-checkout checkstands are becoming more popular as customers grow increasingly frustrated with the wait for traditional manned checkstands, many customers simply avoid the self-checkout checkstands.

In light of the above, it would be advantageous to provide a checkstand that is high speed, and can process purchased products at a high rate of speed. It is also advantageous to provide a checkstand that optimizes the floor space to increase the density of the checkstands in the store given any available floor space. It is also advantageous to provide a checkstand solution that is automated and efficient. It is also advantageous to provide a checkstand solution that is easy to manufacture and maintain, and relatively cost effective.

### SUMMARY OF THE INVENTION

The High Speed Checkstand having Multiple Product Pathways of the present invention includes a primary stage having a customer input conveyor belt which leads to an automated high speed scanner that can scan customer products at speeds wherein the belt advances at eighty feet per minute, and with the capability to successfully scan items that are stacked, piled, or otherwise randomly positioned on the input conveyor belt. Once scanned, the products leave the high speed scanner on the output conveyor to the secondary stage having a central conveyor belt that leads to a diverter which selectively diverts the advancing products to one of two available product conveyor belts. The diverter is controlled to direct product to a specific conveyor belt corresponding to a single customer's order.

The diverter includes a pair of diverter arms that cooperate to direct products advancing on the central conveyor to either the right or left product conveyor belts. These product conveyor belts each lead to a bagging station where the advancing products can be collected and placed in bags for the customer.

The High Speed Checkstand having Multiple Product Pathways of the present invention includes a control system that facilitates the high speed identification of the products passing through the high speed scanner. This is achieved using state-of-the-art bar code scanning, three dimensional objection recognition technologies, and other techniques known in the art. The control system detects the beginning and end of each customer order, and receives data regarding the payment. Additionally, the control system actuates the diverter to selectively direct the customer's purchases to a specific product conveyor belt where a bagging staff member collects and bags the customer's purchases. The control system also includes safety systems that minimize damage to products, monitor the proper functionality of the entire checkstand system, and provides alerts and will interrupt the system in the event of a failure,

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the High Speed Checkstand having Multiple Product Pathways of the present invention showing the primary stage including the input conveyor, scanner and output conveyor, and the secondary stage including the central conveyor with a pair of companion product conveyor belts that each lead to a bagging station with a centrally located diverter which is actuated to select one of two product pathways and controls two cooperative diverting arms to direct products from the central conveyor to either of the two product conveyor belts;

FIG. 2 is a perspective view of the secondary stage of the High Speed Checkstand having Multiple Product Pathways of the present invention showing the central conveyor leading to the pair of companion product conveyor belts that each lead to a bagging station with a centrally located diverter which is actuated to select one of two product pathways and controls two cooperative diverting arms to direct products from the central conveyor to either of the two product conveyor belts;

FIG. 3 is a top view of the secondary stage of the High Speed Checkstand having Multiple Product Pathways of the present invention showing the central conveyor leading to the pair of companion product conveyor belts that each lead to a bagging station with a centrally located diverter which is actuated to select one of two product pathways and controls two cooperative diverting arms to direct products from the central conveyor to either of the two product conveyor belts, and showing a bagging staff member position, and the position of two side rails that prevent products from becoming ensnared by the diverter arms;

FIGS. 4 and 5 are a pair of top views of the High Speed Checkstand having Multiple Product Pathways of the present invention showing the articulation of the cooperative diverter arms from a first position directing the products from the central conveyor to one adjacent product conveyors, to a second position directing products from the central conveyor to the other adjacent product conveyor, and showing the relationship between the left and right diverter arm pivot points and the corresponding swing pins that move in response to activation of the diverter actuator;

FIG. 6 is an enlarged top view of the High Speed Checkstand having Multiple Product Pathways of the present invention showing the diverter and the corresponding movement of the diverter arms from side-to-side of the central conveyor;

FIG. 7 is a top view of the diverter of the High Speed Checkstand having Multiple Product Pathways of the present invention showing a drive assembly having a base with a drive motor connected to a gearbox which activates a linear actuator, and a slide assembly attached to the linear actuator and having a bracket that supports a threaded shaft extending between each swing pin and equipped with adjustment nuts and having a pair of safety and alignment springs that maintain the proper position of the diverter arms yet may be moved when needed for safety;

FIG. 8 is a detailed view of the diverter assembly of the High Speed Checkstand having Multiple Product Pathways of the present invention showing the drive motor connected to a gearbox which activates a linear actuator, and a slide assembly attached to the linear actuator and having a bracket that supports a threaded shaft extending between each swing pin and equipped with adjustment nuts and having a pair of safety and alignment springs that maintain the proper position of the diverter arms, and showing the linear orientation of the slide assembly that, when activated, articulates the diverter arms about fixed pivot pins to create a first position angle and a second position angle corresponding to the desired diverter configuration;

FIG. 9 is an alternative view of the diverter assembly of the High Speed Checkstand having Multiple Product Pathways of the present invention shown in FIG. 8, with the linear actuator in a shortened position to articulate the diverter arms about fixed pivot pins for positioning at the second position angle corresponding to the desired diverter configuration;

FIG. 10 is a side view of the diverter arm of the High Speed Checkstand having Multiple Product Pathways of the present invention showing a base formed with a rectangular bore to transversely receive the swing pin and for placement of a releasing spring that provides a downward force to the diverter arm during use, and a number of hollow cut-outs that are formed within the diverter arm to minimize weight and improve strength;

FIG. 11 is a side view of the opposite side of the diverter arm of the High Speed Checkstand having Multiple Product Pathways of the present invention showing the base formed with a rectangular bore to transversely receive the swing pin and the transverse bore to receive the fixed pivot pin (dashed lines) to define an axis of rotation, and shown with the tip formed with a taper that contacts the adjacent diverter arm and a rounded end to avoid sharp edges and minimize the possible for injury during use; and

FIG. 12 is a top view of the diverter arm of the High Speed Checkstand having Multiple Product Pathways of the present invention showing the base formed with the bore to receive the swing pin and the bore to receive the fixed pivot pin to define an axis of rotation, and shown with the tip formed with a taper that contacts the adjacent diverter arm and a rounded end to avoid sharp edges and minimize the possible for injury during use.

### DETAILED DESCRIPTION

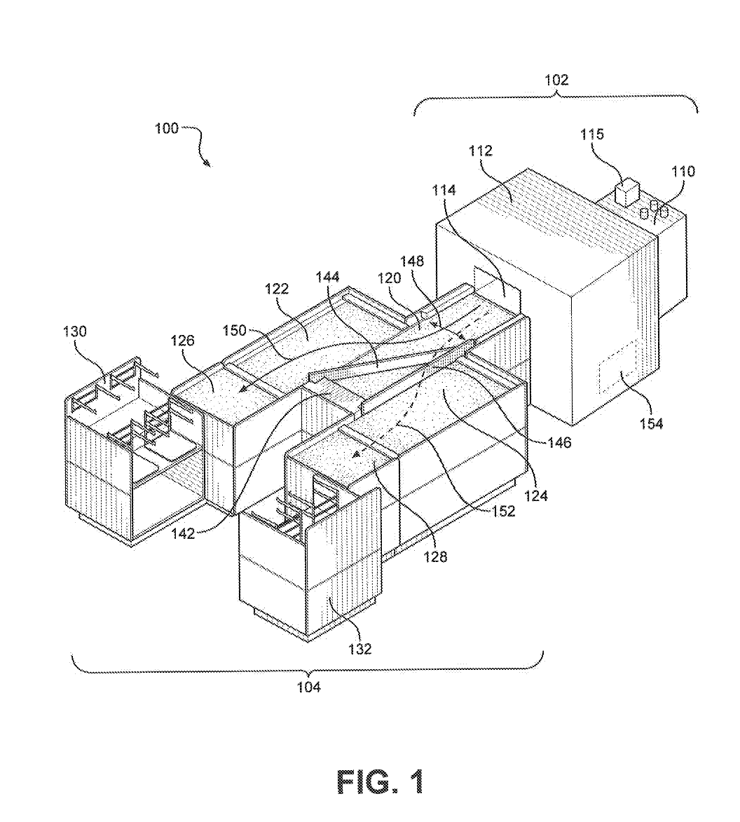

Referring initially to FIG. 1, a perspective view of the High Speed Checkstand having Multiple Product Pathways of the present invention is shown and generally designated 100. High Speed Checkstand 100 includes a primary stage 102 that leads to a secondary stage 104.

Primary stage 102 includes an input conveyor 110 that, like most product conveyors, includes an elongated continuous belt that is rotated by an internal drive motor (not shown). The products 115 placed on conveyor 110 are then advanced towards a high-speed scanner 112. As shown, the input conveyor 110 brings products 115 into and through the high speed scanner 112 for scanning and other product recognition functions.

It is to be appreciated that the high speed scanner 112 incorporates several technologies in order to quickly and accurately identify each specific product 115 within a group of products as those products are conveyed through the scanner 112. These technologies include, but are not limited to, bar code scanning, optical three-dimensional scanning, and product identification algorithms, as well as monitoring and reporting product weight characteristics. As products 115 are advanced through scanner 112, each product is identified and that product's identification data may be stored or used for product cost calculations, for example.

Secondary stage 104 abuts primary stage 102, and includes the central conveyor 120 which is positioned adjacent the output conveyor 114 of the scanner 112. In order to minimize the likelihood that products 115 become stuck or damaged in the transition between the output conveyor 114 and the central conveyor 120, each conveyor belt is supported by rollers (not shown in this Figure) that have a very small diameter such that the angular gap created between the two conveyors is minimal.

On each &de of the central product conveyor 120 is a pair of companion product conveyor belts, namely left conveyor 122 and right conveyor 124. Each companion product conveyor 122 and 124 leads to its own product collection area 126 and 128, respectively. Each product collection area 126 and 128 is equipped with its own bagging station 130 and 132, respectively.

Secondary stage 104 is also equipped with a centrally located diverter 142, which includes a pair of cooperative diverting arms. Specifically, left diverting arm 144 and right diverting arm 146 cooperate such that when actuated, the combination of the two diverting arms swings in direction 148 to direct products from the central conveyor 120 to either of the two product conveyor belts 122 and 124 to select one of two product pathways 150 and 152. More specifically, and as will be described in greater detail below, diverter 142 may be actuated to direct products 115 that are delivered to central conveyor 120 from output conveyor 114 to two specific product pathways 150 and 152, thereby selecting which collection area 126, 128 and bagging station 130, 132 that will be used for those products.

It is to be appreciated from this Figure that the use of the High Speed Checkstand having Multiple Product Pathways 100 of the present invention including diverter 142 to direct product from a single central conveyor 120 to two distinct product pathways 150 and 152, increases the throughput of the checkstand 100 by 100 percent. Indeed, after the products for a first customer have been scanned, passed along product pathway 150, collected on the left bagging station 130, and that customer is paying for their purchase, the diverter 142 can be actuated to divert a second customer's product along product pathway 152 to be collected at the right bagging station 132. In this manner, there is virtually no delay between the scanning of the first customer's products, and the scanning of the second customer's products. In fact, this increased throughput is a stark contrast to the currently available checkstands which typically require a first customer's transaction to be completed in its entirety prior to even beginning the scanning of the second customer's products.

Control of the High Speed Checkstand having Multiple Product Pathways 100 of the present invention is achieved with a controller 154 that may, in a preferred embodiment, be housed within scanner 112. Controller 154 is in electrical connection with input conveyor 110, high speed scanner 112, and output conveyor 114 and is capable of monitoring the positioning and advancement of products. Also, controller 154 is in electrical connection with secondary stage 104 whereby it can control the operation of central conveyor 120, left and right conveyors 122 and 126, and diverter 142. In operation, controller 154 may selectively activate the various conveyors and diverter to direct products from various customers to the different bagging stations 130 and 132. In combination with a cash register or computerized payment system (not shown), the High Speed Checkstand having Multiple Product Pathways 100 of the present invention provides a high-speed solution to current checkstand deficiencies by automating much of the checkout procedure, and increasing the speed with which customers can exit the store when shopping is completed.

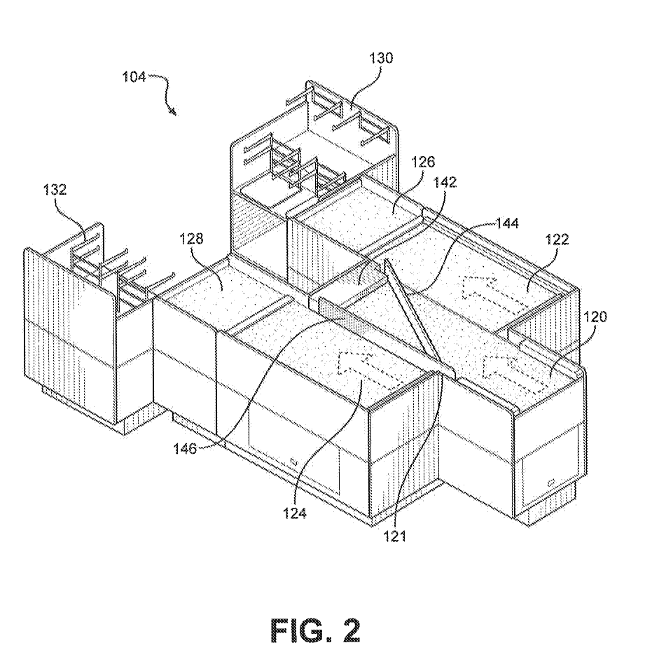

Referring now to FIG. 2, an alternative perspective view of the secondary stage 104 of the High Speed Checkstand having Multiple Product Pathways 100 of the present invention is shown. From this figure, the central conveyor 120 is shown extending between left product conveyor 122 and right product conveyor 124, with all three rotating in the same direction (shown in dashed lines). It is to be appreciated that controller 154 can maintain the rates of conveyors 120, 122 and 124 at the same or nearly same rates to avoid any significant differential between the speeds of the conveyors. Centrally located diverter 142 is positioned at the end of the central conveyor 120 and includes left diverter arm 144 and right diverter arm 146.

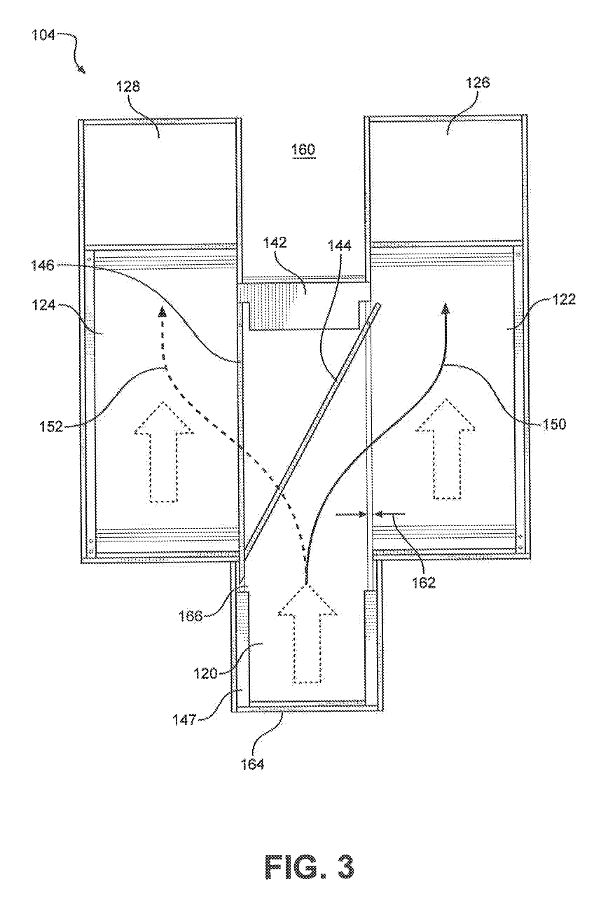

FIG. 3 is a top view of the secondary stage 104 of the High Speed Checkstand having Multiple Product Pathways 100 of the present invention showing the central conveyor 120 leading to the pair of companion product conveyor belts 122 and 124 that each lead to a product collection area 126 and 128.

The centrally located diverter 142 controls the movement of right and left diverter arms 144 and 146 which are moved in unison to select one of two product pathways 150 and 152. Specifically, in a first configuration, diverter 142 is in position with right diverter arm 146 substantially straight along the side of the central conveyor 120, while the left diverter arm 144 is angled towards the right diverter arm 146 to create a product pathway 150 onto left conveyor 122.

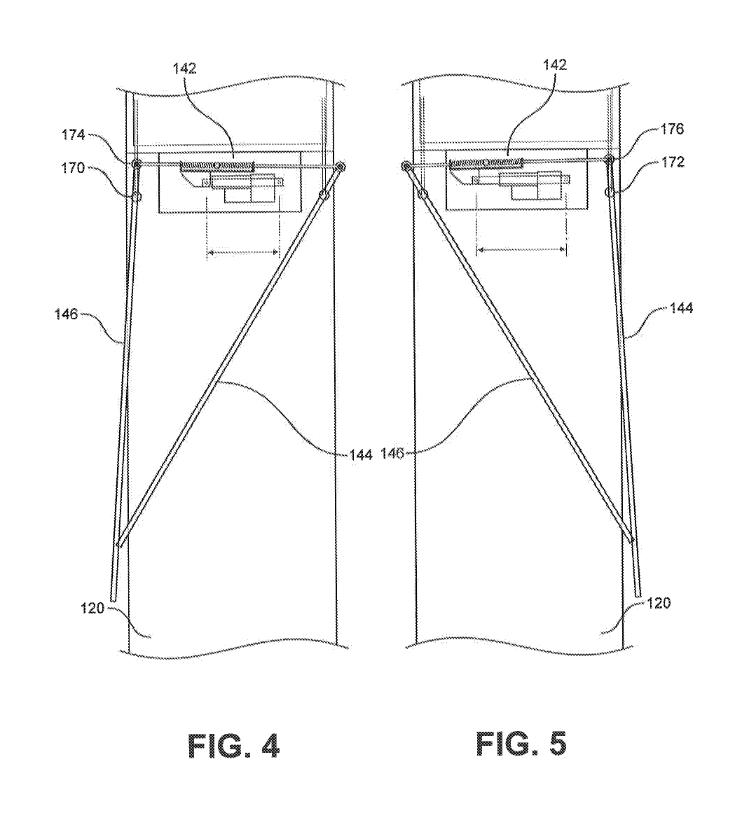

When diverter 142 is actuated, right and left diverter arms 146 and 144 are rotated and repositioned as shown in FIGS. 4 and 5 with the left diverter arm 144 substantially straight along the side of the central conveyor 120, while the right diverter arm 146 is angled towards the left diverter arm 144 to create a product pathway 152 (shown in dashed lines) onto right conveyor 124.

Central conveyor 120 is equipped with a pair of side rails 147 that provide protection from product striking the leading edges of diverter arms 144 and 146 by creating a small offset 166 that prevents products 115 from striking the arms. Also, secondary stage 104 is formed with a mating wall 164 that is intended to butt directly to primary stage 102 such that the output conveyor 114 from scanner 112 deposits products 115 directly onto central conveyor 120.

In order to prevent product from being snagged or damaged during the transfer from central conveyor 120 to left and right side conveyors 122 and 124, belt gap 162 is minimized. Specifically, by reducing the spacing between these conveyors, the space available for product to fall between the two conveyors is minimized. Further, given that the speed of the conveyors is maintained essentially the same, there is no velocity difference between them which would tend to capture product.

FIG. 3 also provides a clear view of the location of a bagging staff person's position in the High Speed Checkstand having Multiple Product Pathways 100 of the present invention. Specifically, a bagger's position 160 is appropriately between the left and right side product collection area 126 and 128. From this position, the bagging staff person could service both conveyors 122 and 124 as products are delivered from scanner 112 through central conveyor 120.

For illustration purposes, FIGS. 4 and 5 are a pair of top views of the High Speed Checkstand having Multiple Product Pathways 100 of the present invention showing the articulation of the cooperative diverter arms 144 and 146. In FIG. 4, diverter arms 144 and 146 are in a first position directing the products from the central conveyor 120 to adjacent left side product conveyor 122 (not shown this Figure). In FIG. 5, diverter arms 144 and 146 are in a second position directing products from the central conveyor 120 to the adjacent right product conveyor 124 (not shown this Figure). From this view, the relationship between the left and right diverter arms 144 and 146 with each arm fixed pivot points 170 and 172 is clear. Specifically, fixed pivot pins 170 and 172 are fixedly mounted and extending upwards from the diverter 142, and do not move in relation to the secondary stage 104. Also shown are the swing pins 174 and 176, which translate perpendicularly to the advancement of central conveyor 120. As shown, by actuating diverter 142, right and left swing pins 174 and 176 are moved to re-position diverter arms 146 and 144, respectively.

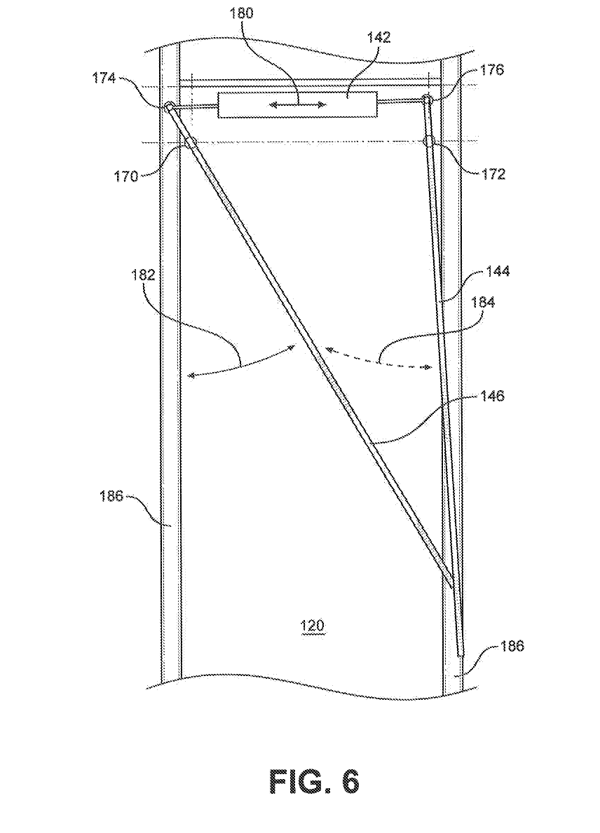

Referring now to FIG. 6, an enlarged top view of the High Speed Checkstand having Multiple Product Pathways 100 of the present invention is shown. From this view, the diverter 142 and the corresponding movement of the diverter arms 144 and 146 can be appreciated. By activating actuator 142, swing pivot pins 174 and 176 are moved in direction 180 in relation to fixed pivot pins 170 and 172 to reposition diverter arms 144 and 146 as shown by arrows 182 and 184.

As shown in this Figure, railings 186 may be provided to central conveyor 120. However, in an alternative embodiment, railings 186 may not be above the surface of the conveyor 120 thereby providing a very small gap 162 (shown in FIG. 3) as described above.

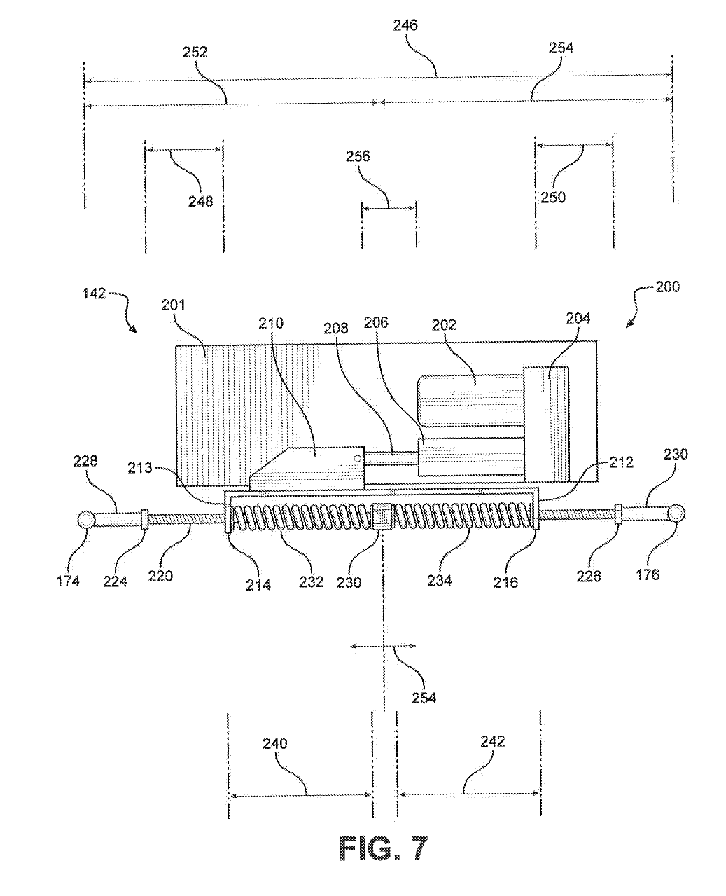

Referring to FIG. 7, a top detailed view of the diverter 142 of the High Speed Checkstand having Multiple Product Pathways 100 of the present invention is shown. This detail is exemplary of a preferred embodiment and provides for the features and benefits discussed herein. Diverter 142 includes a drive assembly 200 which has a base 201and includes a motor 202 mechanically attached to a gearbox 204 which in turn is mechanically attached to linear actuator 206 having a linearly extendable shaft 208. By rotating motor 202, the rotational force is transferred through gear box 204 to rotatably drive linear actuator 206 which in turn advances shaft 208 from actuator 206. Conversely, by reversing motor 202, the shaft 208 is dawn into actuator 206. Motor 202, gearbox 204 and linear actuator 206 are all fixedly mounted to base 201, which is in turn mounted securely to secondary stage 104 and thus in constant position relative to conveyors 120, 122 and 124.

A slide assembly 212 includes a u-shaped bracket 213 that is attached to bracket 210 that is attached to the distal end of shaft 208. From this Figure, it can be appreciated that as motor 202 is rotated in one direction, slide assembly 212 will be advanced in one direction, and as motor 202 is rotated in the opposite direction, slide assembly 212 will be advanced in the opposition direction.

U-shaped bracket 213 has two tabs 214 and 216 which are formed with a bore to receive a threaded shaft 220. Swing pins 174 and 176 each have a threaded sleeve 228 and 230 that is attached to the ends of threaded shaft 220 and tightened with nuts 224 and 226, respectively. Within tabs 214 and 216, and disposed axially over threaded shaft 220, a pair of springs 232 and 234 are provided, and separated by a control and adjustment nut 230. The pair of safety and alignment springs 232 and 234 maintain the proper position of the diverter arms 144 and 146, yet may be moved when needed for safety, such as in the unlikely event product becomes captured by the arm.

In a preferred embodiment, spring lengths 240 and 242 are substantially equal and will typically orient the nut 230 on threaded shaft 220 in the center of bracket 213. As a result, as adjustment nut 230 is rotated relative to shaft 220, the position of left and right swing pins 174 and 176 will shift in direction 254.

In order to provide a means for calibration of the position of the left and right diverter arms 144 and 146, nuts 224 and 226 can be rotated to adjust the lengths 248 and 250, as well as the overall length 246 of the slide assembly 212. Also, lengths 248 and 250 can be adjusted separately such that one side of slide assembly 212 can have a length 252 that is greater or lesser than length 254 of the other side of the slide assembly 212.

It is to be appreciated that the ability to adjust the various lengths discussed above provides the diverter 142 of the High Speed Checkstand having Multiple Product Pathways 100 of the present invention to be configured to virtually any central conveyor dimension, and provides the user the ability to adjust the force with which the diverter arms 144 and 146 strike the sides of the central conveyor chassis 121 (shown in FIG. 2). Moreover, the force exerted between the two diverter arms 144 and 146 can likewise be adjusted to maintain a suitable level of contact without causing undue friction and wear and tear on the diverter arms.

Also from FIG. 7, it is to be appreciated that the actuation of the linear actuator 206 results in the extension or retraction of shaft 208, which in turn translates slide assembly 212 in direction 254. As will be discussed in greater detail below, the translation of slide assembly 212 in direction 254 results in the movement of the diverter arm 144 and 146 from a first position, to a second position.

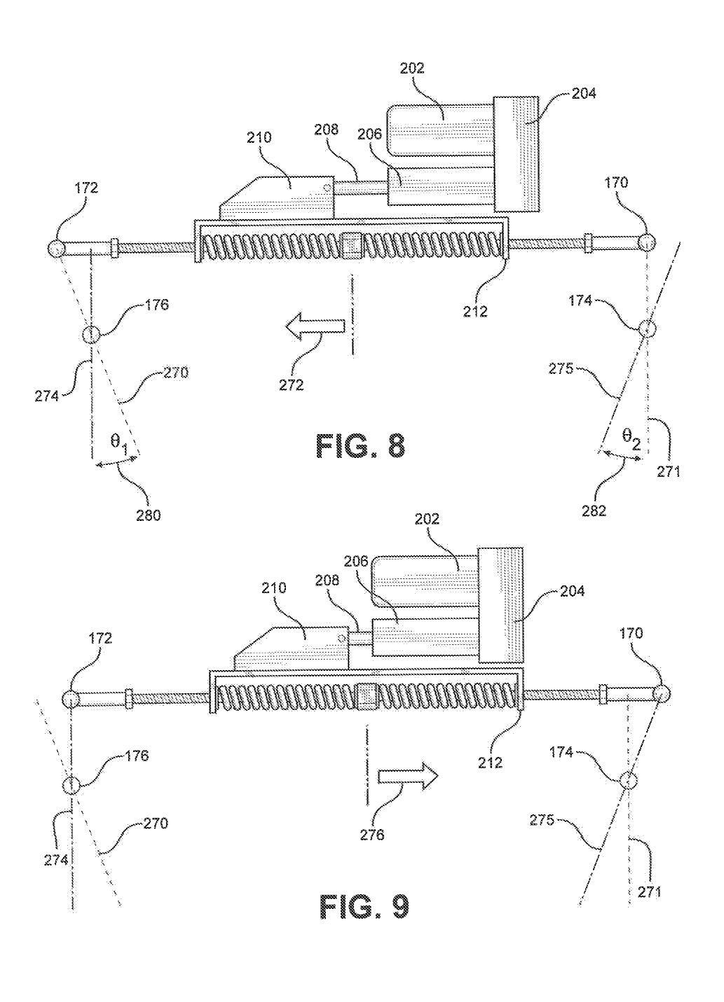

FIGS. 8 and 9 provide top detailed views of the diverter assembly 142 of the High Speed Checkstand having Multiple Product Pathways 100 of the present invention showing its two primary configurations. Referring to FIG. 8, the drive motor 202 is connected to gearbox 204 which activates linear actuator 206 thereby advancing shaft 208 from actuator 206. Bracket 210 of slide assembly 212 is forced in direction 272 such that the swing pins 170 and 172 move in direction 272. Since pivot pins 174 and 176 are fixed relative to base 201 (shown in FIG. 7), a first position set of axes 270 and 271 is defined when the shaft 208 is extended from actuator 206 in direction 272. Similarly, a second position set of axes 274 and 275 is defined when the shaft 208 is retracted into actuator 206.

The first position axis 270 and the second position axis 274 define angle \textcircled{−}₁ 280 and first position axis 271 and the second position axis 275 define angle \textcircled{−}₂ 282. Based on the adjustment capabilities discussed above in conjunction with FIG. 7, it is to be appreciated that angles \textcircled{−}₁ 280 and \textcircled{−}₂ 282 can be the same or different, depending on the particular installation.

FIG. 9 depicts the linear actuator 206 drawing shaft 208 into actuator 206 and slide assembly 212 is forced in direction 276 such that the swing pins 170 and 172 move in direction 276. Again, since pivot pins 174 and 176 are fixed relative to base 201 (shown in FIG. 7), the swing pins are moved from first position axes 270 and 271 to align with the second position axes 274 and 275.

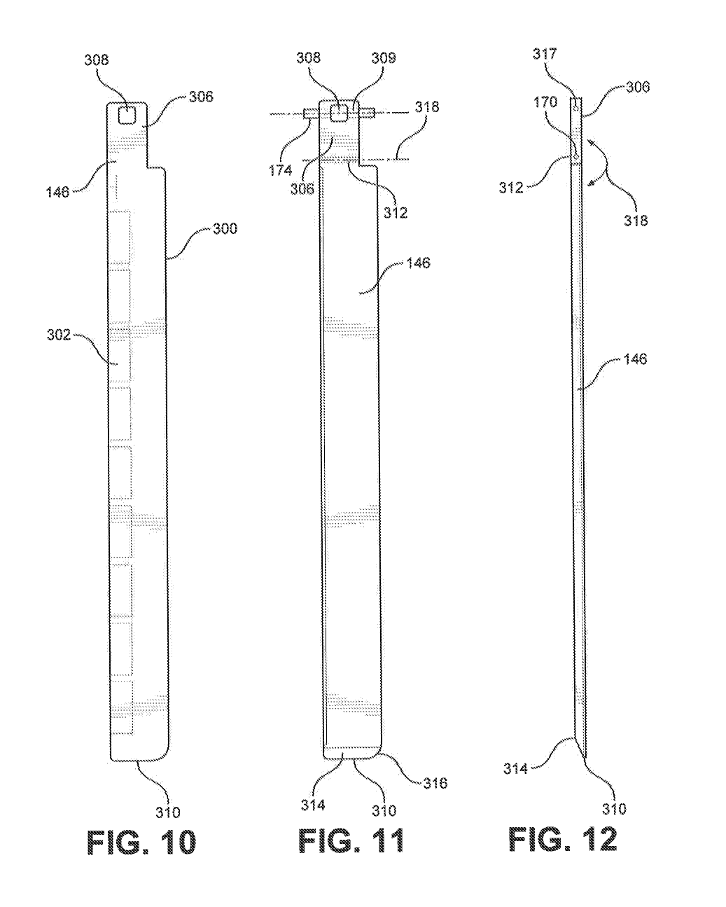

Referring now to FIGS. 10, 11 and 12, an exemplary diverter arm 146 is shown. FIG. 10 is a side view of the diverter arm 146 of the High Speed Checkstand having Multiple Product Pathways 100 of the present invention and shows a base 306 formed with a rectangular bore 308 to transversely receive the swing pin and for placement of a releasing spring (not shown in this Figure) that provides a downward force to the diverter arm 146 during use. Also shown are a number of hollow cut-outs 302 that are formed within the diverter arm 146 to minimize weight and improve strength.

Referring to FIG. 11, a side view of the opposite side of the diverter arm 146 of the High Speed Checkstand having Multiple Product Pathways 100 of the present invention is shown. In this Figure, the base 306 is shown formed with rectangular bore 308 to transversely receive the swing pin 174 which passes axially through a spring 309 that is configured to provide downward force on the diverter arm 146. This spring force can be overcome for cleaning, maintenance, and in the event a product 115 becomes captured between the arm 146 and the conveyor 120.

Also shown in FIG. 11 is the transverse bore 312 to receive the fixed pivot pin (shown in dashed lines) to define an axis of rotation 318, and shown with the tip 310 formed with a taper 314 that contacts the adjacent diverter arm, and a rounded end 316 to avoid sharp edges and minimize the possibility for injury during use.

FIG. 12 is a top view of the diverter arm 146 of the High Speed Checkstand having Multiple Product Pathways 100 of the present invention showing the base 306 formed with the bore 317 to receive the swing pin and the bore 312 to receive the fixed pivot pin 170 to allow rotation 318. Also, the tip 310 is shown formed with taper 314 that contacts the adjacent diverter arm and a rounded end to avoid sharp edges and minimize the possibility for injury during use.

While there have been shown what are presently considered to be preferred embodiments of the present invention, it will be apparent to those skilled in the art that various changes and modifications can be made herein without departing from the scope and spirit of the invention,

1. A high speed checkstand, comprising:
a primary stage having a customer input conveyor belt configured to receive customer products;
an automated high speed scanner adjacent said conveyor belt and configured to scan said customer products;
output conveyor to receive said customer products and transmit said customer products to the secondary stage having a central conveyor belt and a pair of product conveyor belts adjacent said central conveyor belt;
a diverter, positioned on said central conveyor belt and configured to selectively divert said customer products to one of said product conveyor belts,

2. The high speed checkstand of claim 1, wherein said diverter includes a pair of diverter arms configured to cooperate to direct said customer products advancing on the central conveyor to one of said product conveyor belts.
